(19) United States
(12) Patent Application Publication
(10) Pub. No.: US 2024/0425303 A1
(43) Pub. Date: Dec. 26, 2024

(54) Pivotable suction cup device and method

(71) Applicant: RightHand Robotics, Inc., Charlestown, MA (US)

(72) Inventors: Timothy Fofonoff, Cambridge, MA (US); Howard Kellogg, Somerville, MA (US)

(21) Appl. No.: 18/750,141

(22) Filed: Jun. 21, 2024

Related U.S. Application Data
(60) Provisional application No. 63/522,187, filed on Jun. 21, 2023.

(51) Int. Cl. B65G 47/91; B25J 15/06

(52) U.S. Cl. CPC B65G 47/91; B25J 15/0683; B65G 47/917

(57) ABSTRACT

Robotic picking devices and methods. The robotic picking device includes a suction device, a vacuum device in operable connectivity with the suction device and configured to generate a suction force to enable the suction device to grasp an item, and at least one pivotable portion operably connected with the suction device and configured to rotate about an axis during the grasp to align the item's center of mass at least approximately below the suction device.

### CROSS-REFERENCE TO RELATED APPLICATIONS

The present application claims the benefit of and priority to co-pending United States provisional application. No. 63/522,187, filed on Jun. 21, 2023, the entire disclosure of which is incorporated by reference as if set forth in its entirety herein.

### TECHNICAL FIELD

Embodiments described herein generally relate to robotic devices and methods and, more particularly but not exclusively, to robotic devices and methods for grasping items.

### BACKGROUND

Logistic operations such as those in warehouse environments often include robotic devices to gather items from a first location (e.g., a container) and place the items at a second location (e.g., on a conveyor belt). Accordingly, these operations require a robotic device to first grasp the item and then move the item to the appropriate location. Existing robotic devices often include a suction device that imparts a suction force on an item to “grasp” the item.

Robotic devices are often configured with one or more suction devices to impart this suction force to grasp an item. A suction device may grasp the item to perform the picking operation by creating a seal between the suction device and the item, and drawing air out of a volume between the suction device and the item such that a portion of the item is exposed to low pressure. This allows external air pressure to push the item in the direction of the suction device.

The quality of a grasp between a suction device and an item is dependent on creating a quality seal and maximizing the surface area of the item that is inside the seal. Existing techniques for improving seal quality involve conforming the suction device to the item by using flexible lips, foam pads, or the like.

Oftentimes, however, certain items can unevenly load the suction device. For example, a suction device may grasp an item at a location on the item that is “off-center” or otherwise in a way such that the item's center of mass is located away from the suction device. Even if the suction device grasps an item toward the item's center, the item may shift during transport such that the location of the item's center of mass changes. This uneven loading increases the chances of an item detaching from the suction device.

A need exists, therefore, for robotic picking devices that overcome the disadvantages of existing devices.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a robotic picking device. The picking device includes a suction device, a vacuum device in operable connectivity with the suction device and configured to generate a suction force to enable the suction device to grasp an item, and at least one pivotable portion operably connected with the suction device and configured to rotate about an axis during the grasp to align the item's center of mass at least approximately below the suction device.

In some embodiments, the robotic picking device further includes at least one spring to control movement of the at least one pivotable portion to align the item's center of mass at least approximately below the suction device.

In some embodiments, the robotic picking device further includes an upper portion mountable with a robotic arm device, wherein the at least one pivotable portion includes a hinged portion configured to rotate with respect to the upper portion+/−90 degrees. In some embodiments, the at least one pivotable portion further includes a rotatable portion to enable the suction device to rotate at least 360 degrees.

In some embodiments, the robotic picking device further includes an upper portion and a lower portion, wherein the upper portion and lower portion are connected by at least one bearing that allows the lower portion to rotate with respect to the upper portion. In some embodiments, the robotic picking device further includes a channel configured to position at least one spring to enable movement of the at least one pivotable portion to align the item's center of mass at least approximately below the suction device. In some embodiments, the suction force is directed through the at least one bearing. In some embodiments, the robotic picking device further includes a sealing component between the upper portion and the lower portion.

In some embodiments, the at least one pivotable portion is configured to rotate as the center of mass of the item changes position with respect to the suction device.

In some embodiments, the robotic picking device further includes a filter component for capturing debris resultant from the suction force.

According to another aspect, embodiments relate to method of operating a robotic picking device. The method includes positioning a suction device with respect to an item to be grasped, generating a suction force using a vacuum device to enable the suction device to grasp the item, and enabling the suction device to rotate via at least one pivotable portion during the grasp to align the item's center of mass at least approximately below the suction device.

In some embodiments, the method further includes applying a spring force via at least one spring to control movement of the at least one pivotable portion to align the item's center of mass at least approximately below the suction device.

In some embodiments, the robotic picking device includes an upper portion mountable with a robotic arm device, wherein the at least one pivotable portion includes a hinged portion configured to rotate with respect to the upper portion+/−90 degrees. In some embodiments, the at least one pivotable portion further includes a rotatable portion to allow the suction device to rotate at least 360 degrees.

In some embodiments, the robotic picking device includes an upper portion and a lower portion that are connected by at least one bearing that allows the lower portion to rotate with respect to the upper portion. In some embodiments, the robotic picking device includes a channel configured to position at least one spring to enable movement of the at least one pivotable portion to align the item's center of mass at least approximately below the suction device. In some embodiments, the suction force is directed through the at least one bearing. In some embodiments, the robotic picking device includes a sealing component between the upper portion and the lower portion.

In some embodiments, the at least one pivotable portion is configured to rotate as the center of mass of the item changes position with respect to the suction device.

In some embodiments, the robotic picking device further includes at least one filter for capturing debris resultant from the suction force.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates an exemplary warehouse environment in accordance with one embodiment;

FIG. 2 illustrates a robotic picking device in accordance with one embodiment;

FIGS. 3A & 3B illustrate a front view and cross-sectional view, respectively, of a robotic picking device in accordance with one embodiment;

FIG. 4 illustrates a portion of a robotic picking device in accordance with one embodiment;

FIG. 5 illustrates a robotic picking device in accordance with another embodiment;

FIG. 6 illustrates a portion of a robotic picking device in a rotated state in accordance with one embodiment;

FIGS. 7A & 7B illustrate a robotic picking device performing a grasp attempt in accordance with one embodiment; and

FIG. 8 depicts a flowchart of a method of operating a robotic picking device in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

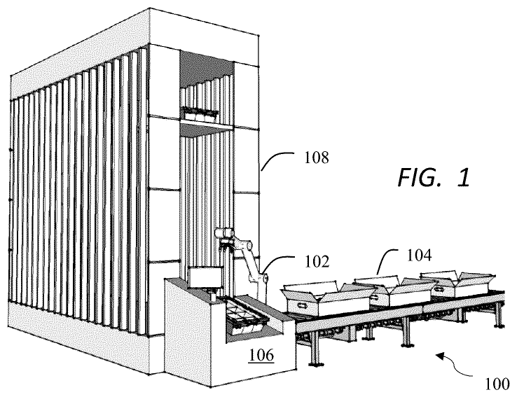

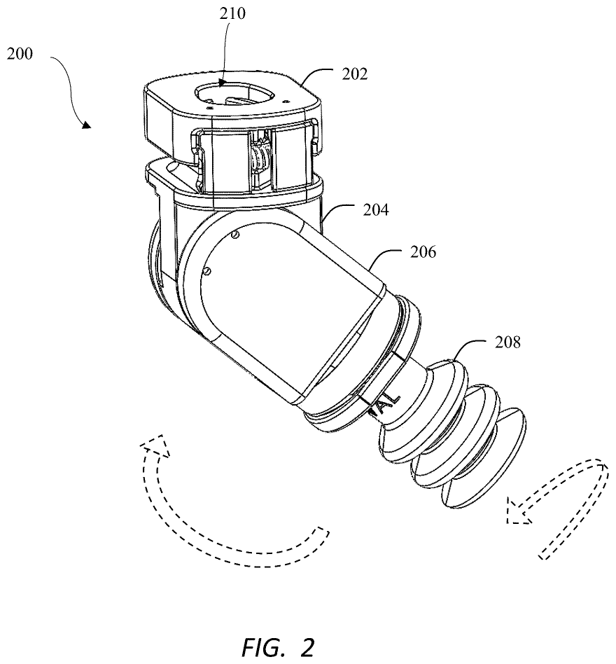

FIG. 1 illustrates an exemplary application in a warehouse environment 100 in which a robotic picking device 102 may be tasked with picking items from one or more containers 104, and placing the items at a loading station 106. These items may then be placed in a shipping container 108 for further shipment, sorting, processing, or the like.

As discussed previously, the robotic picking device 102 may grasp the item in a way such that the item's center of mass is or becomes offset from a suction device. Gravity acting on the item's center of mass creates a moment about the suction device, which may cause the item to detach from the suction device. This may damage the item, contribute to downtime, or require a human operator to intervene (e.g., to pick up the dropped item and complete the task).

A dropped item may also cause a logistics management system tracking items to be unaware that the robotic picking device grasped and subsequently dropped an item. Accordingly, the logistics management system may incorrectly believe that a particular item is at a particular location.

The disclosed embodiments provide novel robotic picking devices and methods for performing grasp attempts. The suction-based robotic picking devices described herein include one or more pivotable portions operably connected with the suction device. The pivotable portion(s) are configured to rotate about an axis during the grasp to align the item's center of mass at least approximately below the suction device. In the context of the present application, the phrase “during the grasp” may refer to the time period in which a robotic picking device provides a suction device on an item such that the item is attached to the robotic picking device.

The robotic picking device(s) (for simplicity, “robotic picking device”) described herein may include one or more springs that control positioning of the suction device with respect to other components of the robotic picking device. These springs may provide a biasing force to orient the suction device based on the location of the item's center of mass.

The robotic picking device described herein may include one or more bearings to connect components of the device to allow rotation of certain components. This rotation may allow movement of certain components to align the item's center of mass at least approximately below the robotic picking device. More specifically, this rotation may align the item's center of mass at least approximately below where the suction device creates a seal with the item.

The features of the described embodiments therefore minimize the amount of stress at the seal between the suction device and the item. Accordingly, the robotic picking device is at least more likely to maintain a seal with the item (and not drop the item) than if the robotic picking device was not able to rotate to position the item's center of mass at least approximately below where the suction device creates a seal with the item.

FIG. 2 illustrates a portion of a robotic picking device 200 in accordance with one embodiment. The robotic picking device 200 may include a coupling mechanism 202 configured to attach to an arm portion (not shown in FIG. 2). The coupling mechanism 202 may be configured with a mounting/extension portion 204 that is in operable connectivity with an adapter 206 that receives or otherwise supports a suction device 208.

The coupling mechanism 202 may include a coupling spring such that the coupling mechanism 202 is spring-loaded to receive and release the arm portion. The coupling mechanism 202 may also include an opening or aperture 210 that can route a suction force through the components of the portion of the robotic picking device 200.

The adapter 206 may be attached to the mounting portion 204 of the coupling mechanism 202 via one or more bearings. This provides a hinged or otherwise pivotable connection between the mounting portion 204 and the adapter 206, and enables the adapter 206 to rotate about the mounting portion 204. In some embodiments, the adapter 206 may rotate+/−90 degrees about the adapter 206.

In some embodiments, the suction device 208 may rotate about the adapter 206 via a bearing. The amount of rotation of the suction device 208 about the adapter 206 may be unlimited and in either direction.

Accordingly, the robotic picking device 200 shown in FIG. 2 provides two pivot or rotation locations. The first location being at the connection between the adapter 206 and the mounting portion 204, and the second being at the location between the adapter 206 and the suction device 208.

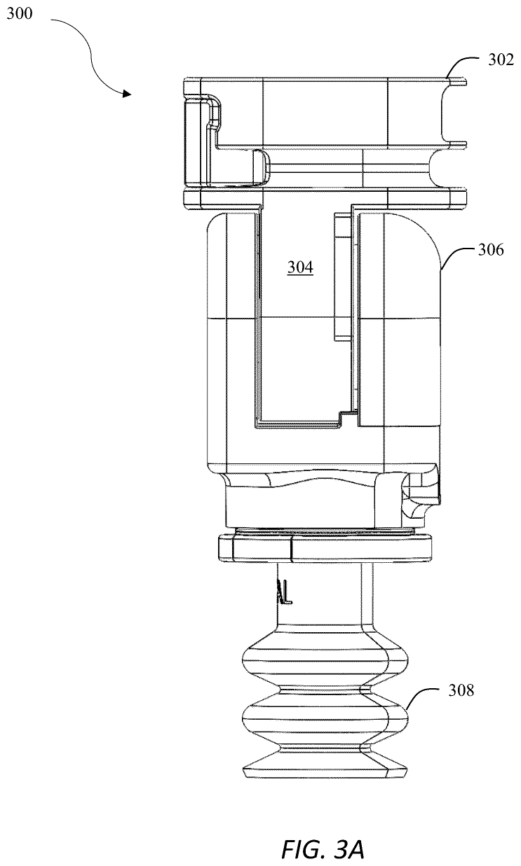

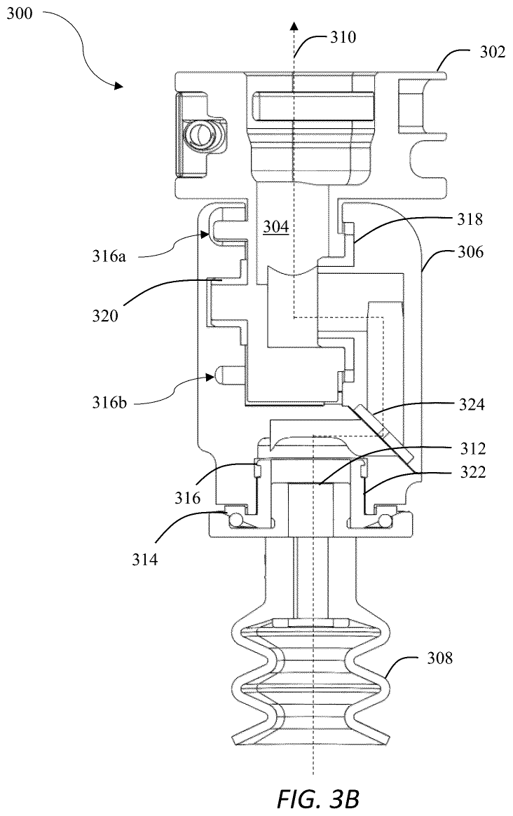

FIG. 3A illustrates a front view of a robotic picking device 300 in accordance with one embodiment. The robotic picking device 300 may be similar to the robotic picking device 200 of FIG. 2 and include a coupling mechanism 302, a mounting portion 304, an adapter 306, a suction device 308. As seen in FIG. 3A, the adapter 306 includes two arm portions that are on opposite sides of the mounting portion 304. As in FIG. 2, the adapter 306 may be connected to the mounting portion 304 via one or more bearings (not shown in FIG. 3A).

FIG. 3B illustrates a cross-sectional view of the robotic picking device 300 of FIG. 3A in accordance with one embodiment. FIG. 3B also illustrates the route of a suction force 310 (illustrated as a dashed line) through the robotic picking device 300. As seen in FIG. 3B, the suction force 310 is directed through a flow path through the suction device 308, the adapter 306, the mounting portion 304, and the coupling mechanism 302. A Venturi device (not shown in FIG. 3B) or equivalent may be in fluid connectivity with the components of the robotic picking device 300 to generate the suction force 310.

The robotic picking device 300 may also include a filter 312 positioned within the suction device 308 or otherwise within the channel that directs the suction force 310. This helps capture or prevent debris from entering the air path. The filter 312 may be formed from a screen or mesh portion that is sized to catch debris.

The robotic picking device 300 may include or otherwise be in connectivity with one or more barb portions 314 for aiding in securing the suction device 308 to the adapter 306. In some embodiments, the barb portion(s) 314 may include a series of threads that engage or are engaged by threads on the suction device 308. The robotic picking device 300 may also include any appropriate seals such as an O-ring to create a seal between the barb portion(s) 314 and the suction device 308.

The robotic picking device 300 may include anchors or stops 316a and 318b configured on or with the mounting portion 304. The anchors 316a and 318b may support one or more springs (not shown in FIG. 3B) that provide a biasing force to the adapter 306 with respect to the coupling mechanism 302 and mounting portion 304. Although not shown in FIG. 3B, the spring may be positioned within a channel that extends between the anchors 316a and 316b.

The robotic picking device 300 may include a plurality of bearings for connecting the components thereof. Bearing 318 may be a sleeve bearing that connects the adapter 306 to a first side (e.g., the right side in FIG. 3B) of the mounting portion 304. Bearing 320 may be a sleeve bearing that connects the adapter 306 to a second side (e.g., the left side in FIG. 3B) of the mounting portion 304. The bearings 318 and 320 may enable rotation of the adapter 306 about the mounting portion 304.

The robotic picking device 300 may further include bearing 322 positioned between the suction device 308 and the adapter 306. Bearing 322 may also be a sleeve bearing, and may enable the suction device 308 to rotate about or otherwise with respect to the adapter 306.

The robotic picking device 300 may include additional O-rings between components thereof to maintain a seal therebetween. For example, O-ring 324 may be positioned between a portion of the adapter 306 and the suction device 308. Other O-rings or equivalent may be positioned throughout the robotic picking device 300.

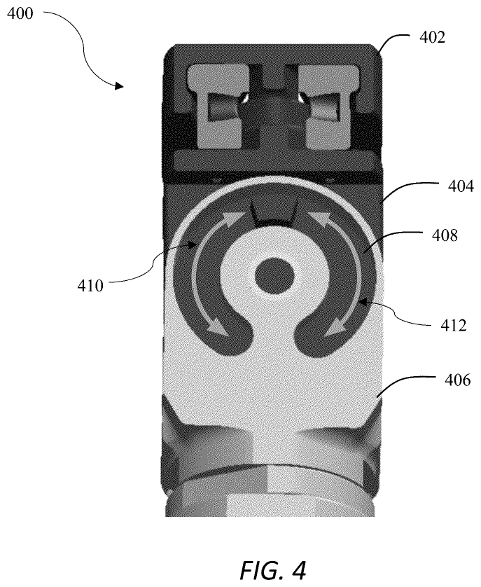

FIG. 4 illustrates a portion of a coupling mechanism 402, mounting portion 404, and an adapter 406 in accordance with one embodiment. The mounting portion 404 and adapter 406 may be similar to the mounting portion 304 and adapter 306, respectively, of FIGS. 3A & B. As discussed in conjunction with FIG. 3B, a portion of the adapter 406 includes a channel portion 408. The channel portion 408 may be sized to receive one or more springs (not shown in FIG. 4) to provide biasing forces 410 and 412 illustrated as bi-directional arrows).

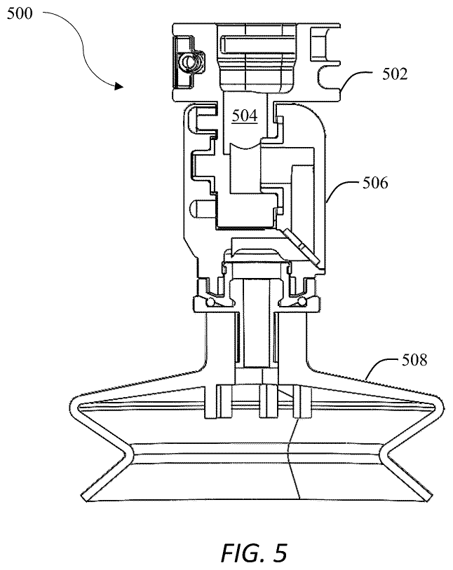

FIGS. 3A & B illustrate a robotic picking device in accordance with one embodiment. The robotic picking device in accordance with the embodiments herein may be configured in a variety of ways or configurations. FIG. 5 illustrates a robotic picking device 500 in accordance with another embodiment. The robotic picking device 500 may be similar to the robotic picking device 300 of FIGS. 3A & B, and may include a coupling mechanism 502, mounting portion 504, and adapter 506.

The robotic picking device 500 may further include a suction device 508. However, the suction device 508 may be larger than the suction device 308 of FIGS. 3A & B. For example, the suction device 508 may be tasked with grasping larger items or items that require a stronger suction force. The remaining structure of the robotic picking device 500 may be similar to the structure of the robotic picking device of FIGS. 3A & B. The robotic picking devices described herein may be modular in that they can receive differently-configured or differently sized suction devices.

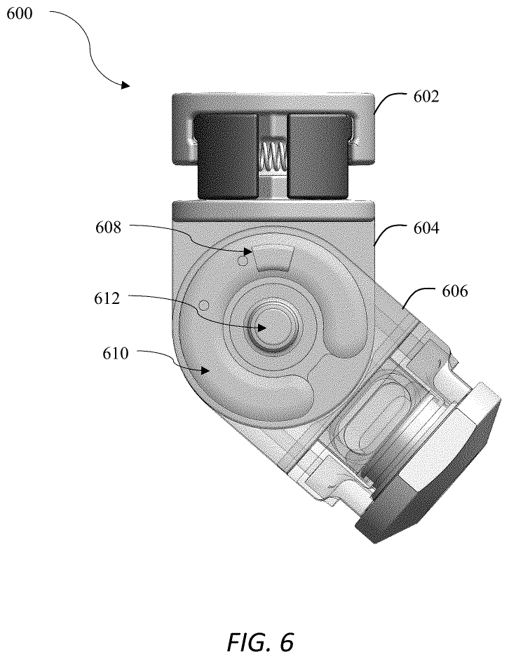

FIG. 6 illustrates a portion of a robotic picking device 600 in accordance with one embodiment. The robotic picking device 600 may be similar to the devices discussed above, and may include a coupling mechanism 602, mounting portion 604, adapter 606, and a suction device (not shown in FIG. 6). FIG. 6 further illustrates a stop portion 608, which is part of the mounting portion 604. As discussed previously, the adapter 606 includes a channel 610 with one or more springs (not shown in FIG. 6) to provide biasing forces in the directions indicated in FIG. 4. In operation, a change in location of an item's center of mass during a picking operation may cause a spring within the channel 610 to force the adapter 606 to rotate about mounting portion 604 at the bearing 612 or otherwise an axis thereof.

In operation, the robotic picking device 600 may be at a neutral position before a grasp attempt. For example, the adapter 606 may be pointed downward such that a suction device is positioned to grasp an item directly below the suction device.

Once the robotic picking device has grasped the item, the picking device may be tasked with moving the item to another location. During this movement, however, the item's center of mass may shift to a different position with respect to the robotic device than what it was earlier in the picking process.

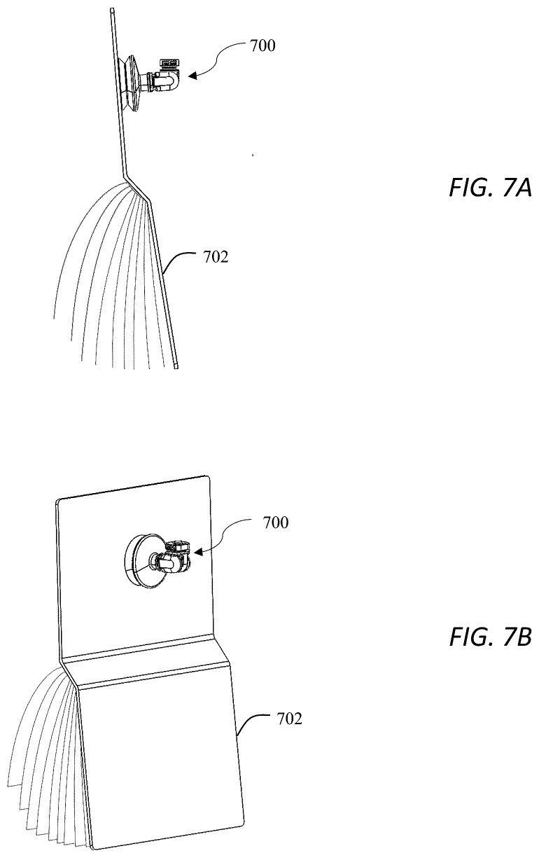

For example, FIGS. 7A & 7B illustrate a robotic picking device 700 performing a picking operation on a book 702. The robotic picking device 700 may be similar to the picking device 600 of FIG. 6 and those discussed previously. During the grasping operation, the book 702 may “open” to a position or orientation such as the one illustrated in FIGS. 7A & 7B. The book may have initially been resting on its side or on a shelf before the grasp attempt.

The “opening” of the book 702 to the position shown in FIGS. 7A & 7B may have shifted the location of the book's center of mass with respect to the robotic picking device 700. Rigid suction cup devices would in this case experience a large amount of stress at the seal between the suction device and the book. This would likely cause the item to detach from the suction device and result in damage to the item, contribute to downtime, etc.

However, in accordance with the described embodiments, the change in location of the center of mass may cause the adapter to rotate about the mounting portion to a position as seen in FIGS. 7A & 7B. Once the robotic device has shifted to this position, the center of mass of the book 702 in FIGS. 7A & 7B is below or at least approximately below the suction device 708. Although there is still stress between the suction cup device and the item, it is significantly less than the stress that would be created if the adapter remained at its initial position, such as pointing downward.

The robotic picking device, while in the position shown in FIGS. 7A & 7B, may then move the book 702 toward the designated place location for further processing or shipment. The place location may be a shelf, bin, conveyor belt, mobile robot, etc. To release the book, the robotic picking device may generate an exhaust force or at least stop the suction force. Upon releasing the book, the spring(s) within the channel of the adapter may return the adapter back to a neutral position.

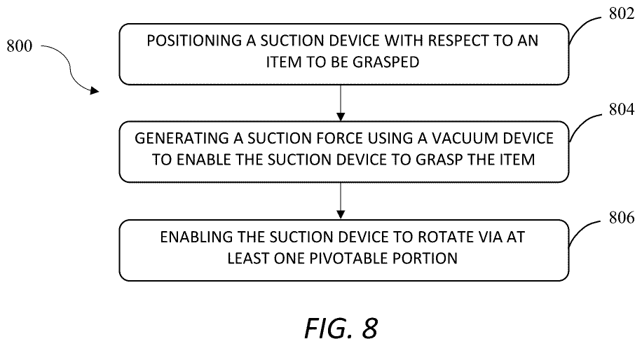

FIG. 8 depicts a flowchart of a method 800 of operating a robotic picking device in accordance with one embodiment. Any of the robotic picking devices or applicable components thereof of the preceding embodiments may perform the steps of method 800.

Step 802 involves positioning a suction device with respect to an item to be grasped. A robotic picking device may include a series of arm linkages to maneuver a suction device to a picking location. The robotic picking device may include, be configured with, or otherwise rely on one or more sensors and processing equipment for determining the location of an item to be picked as part of a picking operation. Accordingly, step 802 may involve positioning a suction device such as devices 208, 308, or 508 near an item to be picked as part of a picking operation.

Step 804 involves generating a suction force using a vacuum device to enable the suction device to grasp the item. For example, a vacuum device described herein may be a Venturi device that is in operable connectivity with the suction device such that the suction device is able to impart a suction force on the item to grasp the item. As discussed previously, the quality of a grasp between a suction device and an item is dependent on creating a quality seal and maximizing the surface area of the item that is inside the seal.

Step 806 involves enabling the suction device to rotate via at least one pivotable portion during the grasp to align the item's center of mass at least approximately below the suction device. Step 806 may further involve applying a spring force via at least one spring to control movement of the at least one pivotable portion to align the item's center of mass at least approximately below the suction device.

As discussed previously, the center of mass of an item may change location during movement of the item. This is particularly true of items that may “open” such as notepads or books. This is also true of items that have an uneven weight in which their weight is concentrated at one end (e.g., a golf club, shovel, etc.), or boxes that have item(s) that can shift or change position within the box.

In step 806, therefore, the robotic picking device rotates about at least one pivotable portion to align the item's center of mass at least approximately below the suction device. For example, in some embodiments, the robotic picking device includes an upper portion (e.g., mounting portion 204, 304, or 504) mountable with a robotic arm device, wherein the at least one pivotable portion includes a hinged portion (e.g., adapter 206, 306, 506) that is configured to rotate with respect to the upper portion+/−90 degrees. For example, the hinged portion may refer to the bearings 318 and 320 that allow the adapter 306 to rotate about the mounting portion 304. Additionally, the at least one pivotable portion is configured to rotate as the center of mass of the item changes position with respect to the suction device throughout the duration of the picking operation.

In some embodiments, the at least one pivotable portion further includes a rotatable portion to allow the suction device to rotate at least 360 degrees. For example, the robotic picking device may include a bearing such as bearing 322 configured between the adapter 306 and suction device 308 of FIGS. 3A & 3B. This allows the suction device to rotate in either direction based on movement of the item's center of mass. There may be no limit to the amount of rotation of the suction device.

The embodiments described are also passive in nature, in that are no additional devices, systems, motors, actuators, etc., required to align the item's center of mass at least approximately below the suction device. Rather, the components of the described embodiments such as spring(s) described herein may adjust the position of the robotic picking device in response to changes in the location of the item's center of mass.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A robotic picking device comprising:
a suction device;
a vacuum device in operable connectivity with the suction device and configured to generate a suction force to enable the suction device to grasp an item; and
at least one pivotable portion operably connected with the suction device and configured to rotate about an axis during the grasp to align the item's center of mass at least approximately below the suction device.

2. The robotic picking device of claim 1 further comprising at least one spring to control movement of the at least one pivotable portion to align the item's center of mass at least approximately below the suction device.

3. The robotic picking device of claim 1 further comprising an upper portion mountable with a robotic arm device, wherein the at least one pivotable portion includes a hinged portion configured to rotate with respect to the upper portion+/−90 degrees.

4. The robotic picking device of claim 3 wherein the at least one pivotable portion further includes a rotatable portion to enable the suction device to rotate at least 360 degrees.

5. The robotic picking device of claim 1 further comprising an upper portion and a lower portion, wherein the upper portion and lower portion are connected by at least one bearing that allows the lower portion to rotate with respect to the upper portion.

6. The robotic picking device of claim 5 further comprising a channel operably positioned between the upper portion and the lower portion, wherein the channel is configured to position at least one spring to enable movement of the at least one pivotable portion to align the item's center of mass at least approximately below the suction device.

7. The robotic picking of claim 5 wherein the suction force is directed through the at least one bearing.

8. The robotic picking device of claim 5 further comprising a sealing component between the upper portion and the lower portion.

9. The robotic picking device of claim 1 wherein the at least one pivotable portion is configured to rotate as the center of mass of the item changes position with respect to the suction device.

10. The robotic picking device of claim 1 further comprising a filter component for capturing debris resultant from the suction force.

11. A method of operating a robotic picking device, the method comprising:
positioning a suction device with respect to an item to be grasped;
generating a suction force using a vacuum device to enable the suction device to grasp the item; and
enabling the suction device to rotate via at least one pivotable portion during the grasp to align the item's center of mass at least approximately below the suction device.

12. The method of claim 11 further comprising applying a spring force via at least one spring to control movement of the at least one pivotable portion to align the item's center of mass at least approximately below the suction device.

13. The method of claim 11, wherein the robotic picking device includes an upper portion mountable with a robotic arm device, wherein the at least one pivotable portion includes a hinged portion configured to rotate with respect to the upper portion+/−90 degrees.

14. The method of claim 13, wherein the at least one pivotable portion further includes a rotatable portion to allow the suction device to rotate at least 360 degrees.

15. The method of claim 11, wherein the robotic picking device includes an upper portion and a lower portion that are connected by at least one bearing that allows the lower portion to rotate with respect to the upper portion.

16. The method of claim 15 wherein the robotic picking device includes a channel operably positioned between the upper portion and the lower portion, the curved channel being configured to position at least one spring to enable movement of the at least one pivotable portion to align the item's center of mass at least approximately below the suction device.

17. The method of claim 15 wherein the suction force is directed through the at least one bearing.

18. The method of claim 15 wherein the robotic picking device includes a sealing component between the upper portion and the lower portion.

19. The method of claim 11 wherein the at least one pivotable portion is configured to rotate as the center of mass of the item changes position with respect to the suction device.

20. The method of claim 11, wherein the robotic picking device further includes at least one filter for capturing debris resultant from the suction force.
